(19) United States
(12) Patent Application Publication
(10) Pub. No.: US 2022/0361689 A1
(43) Pub. Date: Nov. 17, 2022

(54) A FLOW CONTROL DEVICE FOR A REFRIGERATED DISPLAY CASE AND A REFRIGERATED DISPLAY CASE

(71) Applicants: Wirth Research Limited, Bicester Oxfordshire (GB); Light Energy Australia Pty Ltd, North Sydney, New South Wales (AU)

(72) Inventors: Nicholas WIRTH, Northamptonshire (GB); Dugal Campbell, New South Wales (AU)

(73) Assignees: Wirth Research Limited, Bicester Oxfordshire (GB); Light Energy Australia Pty Ltd, North Sydney, New South Wales (AU)

(21) Appl. No.: 17/755,089

(22) PCT Filed: Sep. 30, 2020
(86) PCT No.: PCT/EP2020/077382

§ 371 Date: Apr. 21, 2022

(30) Foreign Application Priority Data
Oct. 25, 2019 (GB) 1915506.8

(51) Int. Cl. A47F 3/04; A47F 3/00

(52) U.S. Cl. CPC A47F 3/0447; A47F 3/001; A47F 2003/046

(57) ABSTRACT

A flow control device for controlling an air curtain formed across a display area of a refrigerated display case, the flow control device comprising: a stabilizing beam comprising an elongate outer cover and a carrier; wherein the outer cover forms a continuous boundary which defines a cavity extending along the length of the outer cover; wherein the carrier is slidably received within the cavity along the length of the outer cover; wherein the carrier is provided with a light source and wherein at least a portion of the outer cover is transparent or translucent such that light emitted by the light source is emitted from the outer cover to provide illumination.

### CROSS-REFERENCE TO RELATED APPLICATIONS

This application is the U.S. national stage of PCT/EP2020/077382 filed on Sep. 30, 2020, which claims priority of Great Britain Patent Application No. 1915506.8 filed on Oct. 25, 2019, the contents of which are incorporated herein.

### TECHNICAL FIELD

The disclosure relates to a flow control device for a refrigerated display case and a refrigerated display case.

### BACKGROUND

The display of chilled or frozen items is commonplace in many retail environments, most notably in supermarkets. Such items are often displayed in refrigerated display cases having hinged or sliding doors, or having an open front. Refrigerated display cases utilise an air curtain which is cooled to below ambient temperature and propelled downward, across the front of the display case (either over the open front or behind the refrigerator doors).

The energy consumed by such refrigerated display cases presents a significant contribution to the overall energy consumption of the supermarket. It is therefore desirable to improve the efficiency of refrigerated display cases.

It has previously been proposed to provide an open refrigerated display case in which each shelf of a display area is provided with a flow control device which stabilises flow in the air curtain. Such a flow control device is disclosed in GB2527628B.

### OBJECT OF THE DISCLOSURE

The disclosure seeks to provide developments relating to the use of flow control devices.

### SUMMARY

According to an aspect of the disclosure there is provided a flow control device for controlling an air curtain formed across a display area of a refrigerated display case, the flow control device comprising: a stabilising beam comprising an elongate outer cover and a carrier; wherein the outer cover forms a continuous boundary which defines a cavity extending along the length of the outer cover; wherein the carrier is slidably received within the cavity along the length of the outer cover; wherein the carrier is provided with a light source and wherein at least a portion of the outer cover is transparent or translucent such that light emitted by the light source is emitted from the outer cover to provide illumination.

The outer cover may be formed from a plastic material.

The outer cover may comprise an opaque portion and the transparent or translucent portion.

The opaque portion may be coextruded with the transparent or translucent portion.

The carrier may be formed from metal.

The carrier may be an aluminium extrusion.

The carrier may comprise a recess having a mounting surface and a reflector surface; wherein the light source is mounted to the mounting surface and is configured to direct light towards the reflector surface which reflects the light through the outer cover.

The carrier and/or an interior surface of the outer cover may comprise a plurality of protrusions to allow the carrier to slide into the cavity.

The flow control device may be configured to be positioned so that the stabilising beam is spaced away from an adjacent shelf of the refrigerated display case such that light emitted from the outer cover illuminates products supported on and/or below the adjacent shelf.

The stabilising beam may be a first stabilising beam and the flow control device may further comprise a second stabilising beam spaced from the first stabilising beam to form a first slot therebetween; wherein the flow control device is configured such that the first stabilising beam is spaced from an adjacent shelf in use to form a second slot therebetween.

According to an aspect of the disclosure there is provided refrigerated display case comprising: a refrigerated display area which comprises a shelf; an air outlet and an air inlet opening into the display area and spaced from one another; a duct fluidically coupling the air inlet to the air outlet, the duct being configured to direct air flow out of the air outlet across the display area and toward the air inlet to form an air curtain across the front of the display area; and a flow control device according to any of the preceding claims, the flow control device being associated with the shelf; wherein light emitted from the outer cover illuminates products supported on and/or below the associated shelf.

The disclosure extends to refrigerated display cases and flow control devices having any combination of the features described herein, except such combinations as are mutually exclusive.

### BRIEF DESCRIPTION OF THE DRAWINGS

For a better understanding of the disclosure, and to show more clearly how it may be carried into effect, reference will now be made, by way of example, to the accompanying drawings, in which:

FIG. 1 is a side cross-sectional view of an open refrigerated display case (ORDC) comprising a flow control device;

FIG. 2 is a perspective view of the flow control device;

FIG. 3 is a side view of the flow control device of FIG. 2;

FIG. 4 is a rear perspective view of the flow control device;

FIG. 5 is a rear perspective view showing an end of an inner beam of the flow control device; and

FIG. 6 is a side cross-sectional view of the inner beam.

### DETAILED DESCRIPTION OF THE DISCLOSURE

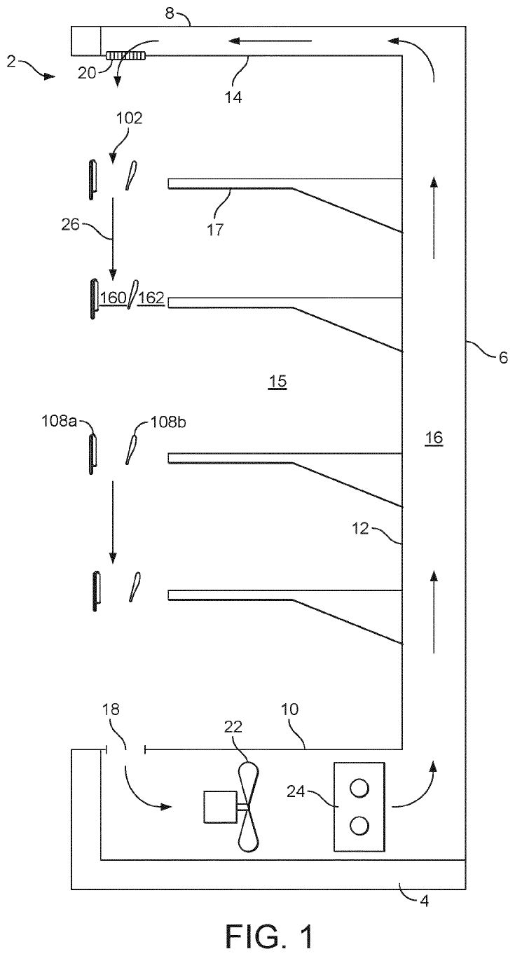

FIG. 1 shows an ORDC 2. The ORDC 2 comprises a cabinet portion formed by a lower wall 4, a back wall 6, an upper wall 8, and left and right side walls (not shown). A lower panel 10, a back panel 12 and an upper panel 14 are disposed within the cabinet portion.

The lower, back and upper panels 10, 12, 14 form a display area 15 which is provided with a plurality of shelves 17 (four are shown) on which items may be displayed. The shelves 17 are affixed to the back panel 12.

As shown, the lower, back and upper panels 10, 12, 14 are spaced from the respective lower, back and upper walls 4, 6, 8 to form a duct 16. An intake grille 18 is provided at the lower panel 10 to form an inlet to the duct 16. Similarly, a discharge grille 20 is provided at the upper panel 14 to form an outlet from the duct 16. The intake grille 18 and the discharge grille 20 are thus fluidically coupled to one another by the duct 16. The intake grille 18 and the discharge grille 20 are spaced from the back panel 12 toward the front of the cabinet portion and ahead of the shelves 17.

A fan 22 and a heat exchanger 24 are located within the duct 16 adjacent to the intake grille 18 and thus are disposed between the lower wall 4 and the lower panel 10. The fan 22 draws air into the duct 16 via the intake grille 18 which then passes through the heat exchanger 24 where it is cooled to well below the ambient temperature.

After passing through the heat exchanger 24, the air continues through the duct 16 between the back wall 6 and the back panel 12. The back panel 12 is perforated allowing air to pass from the duct 16 into the display area 15 where it cools items located on the shelves 17 and on the lower panel 10.

The remaining air flows through the duct 16 to the discharge grille 20. The air is ejected from the discharge grille 20 and descends over the open front of the display area 15 to form an air curtain 26. The air curtain 26 passes from the discharge grille 20 to the intake grille 18, where it is drawn in by the fan 22 and re-circulated through the duct 16. The air curtain 26 thus forms a non-physical barrier which separates the display area 15 from the ambient air surrounding the ORDC 2.

As shown, a flow control device 102 is attached to each of the shelves (although, in other arrangements, only some of the shelves may be provided with flow control devices 102).

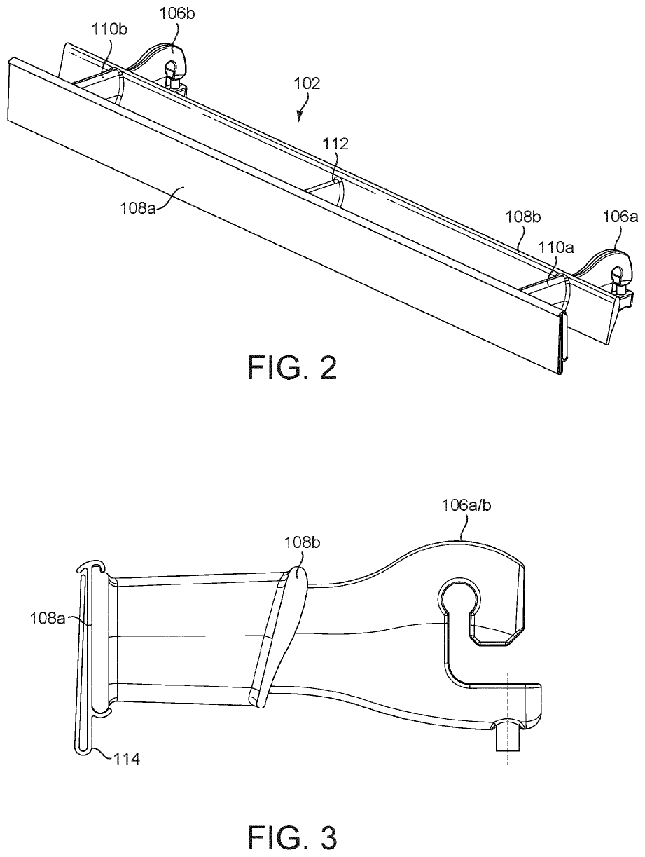

As shown in FIGS. 2 and 3, the flow control device 102 comprises a pair of brackets 106a, 106b and a pair of elongate elements in the form of stabilising beams 108a, 108b. The brackets 106a, 106b are used to attach the device 102 to a shelf. The beams 108a, 108b are connected by a pair of spacers 110a, 110b. The spacers 110a, 110b are provided towards the lateral ends of the beams 108a, 108b. A central spacer 112 may also be provided at the centre of the beams 108a, 108b, midway along their lengths.

The beams 108a, 108b are spaced apart from one another by the spacers 110a, 110b such that upper edges and lower edges of the beams 108a, 108b run parallel to one another. The beams 108a, 108b are, however, angled relative to one another so that a gap between the beams 108a, 108b tapers, with the upper edges of the beams 108a, 108b being further apart than the lower edges.

As shown in FIG. 3, the outer beam 108a may be arranged substantially vertically (i.e. with its upper and lower edges aligned in a vertical plane) and the inner beam 108b may be angled so as to form a tapering gap between the beams 108a, 108b.

The device 102 may further comprise a product information strip 114. As shown in FIG. 3, the product information strip 114 clips over the upper and lower edges of the outer beam 108a. The product information strip 114 has a channel for receiving tickets which display information regarding products, such as the product's price.

As shown in FIG. 1, the beams 108a, 108b define a first slot 160 between the outer and inner beams 108a, 108b and a second slot 162 between the inner beam 108b and the outer surface of the shelf.

The first slot 160 tapers from an inlet at an upper end to an outlet at a lower end. The inlet has a greater width than the outlet and a convergent throat is disposed between the inlet and the outlet.

The beams 108a, 108b are positioned such that the air curtain 26 passes through the first and second slots 160, 162. The beams 108a, 108b act to control and stabilise the air curtain so as to maximise the air which is returned to the intake grille 18 and prevent air from spilling out of the ORDC 2.

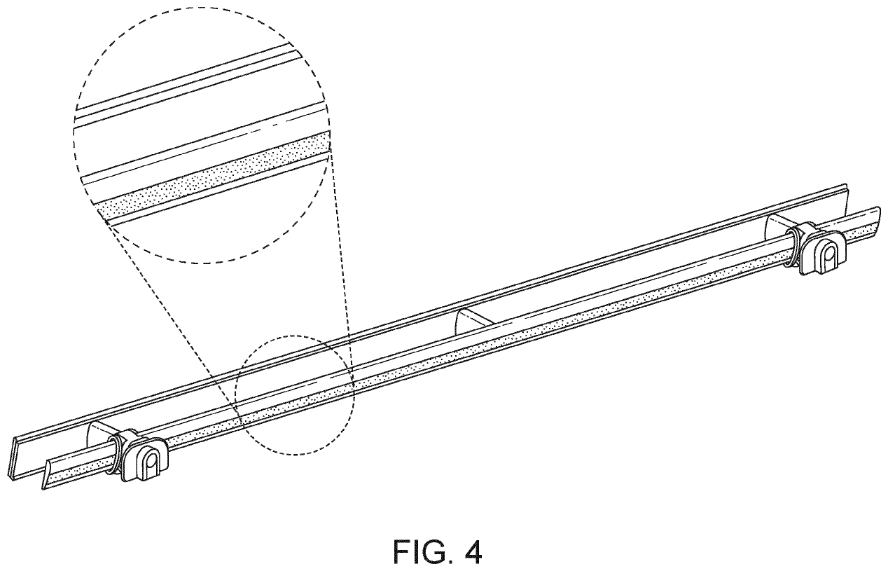

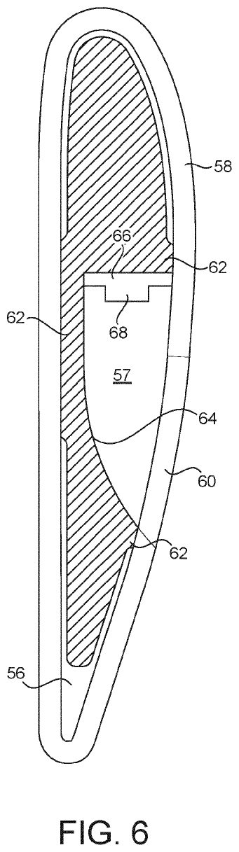

FIGS. 4 to 6 show the inner beam 108b in further detail. As shown, the inner beam 108b comprises an outer cover 52 and a separate carrier 54 which is detachably connected to the outer cover 52.

The outer cover 52 is an elongate member which defines the outer aerodynamic profile of the inner beam 108b. The outer cover 52 is hollow and thus defines a cavity 56 therewithin. The outer cover 52 comprises an opaque portion 58 and a transparent (or translucent) portion 60. The transparent portion 60 is located on an inner surface (i.e. facing towards the shelf) of the inner beam 108b, partway between an upper, leading edge and a lower, trailing edge. The transparent portion 60 forms a window which extends along the length of the inner beam 108b. The opaque portion 58 forms the remainder of the outer cover 52. The opaque portion 58 thus extends from an upper edge of the transparent portion 60 to form an upper portion of the inner surface, the upper edge, the outer surface (i.e. facing away from the shelf), the lower edge and a lower portion of the inner surface, before terminating at a lower edge of the transparent portion 60. Consequently, the outer cover forms a continuous boundary (i.e. a loop) which is open only at one or both ends.

The outer cover 52 is formed from a plastic material. The outer cover 52 may be coextruded such that the opaque portion 58 and the transparent portion 60 are integrally formed and thus continuous. Consequently, the outer cover 52 is intrinsically watertight and there is no need to provide any additional sealing between the opaque portion 58 and the transparent portion 60 along the length of the inner beam 108b (although one or both ends of the outer cover 52 may be provided with an end cap (not shown) to provide appropriate sealing). Further, the provision of the transparent portion 60 does not lead to any artefacts along the surface which would be detrimental to the aerodynamic properties of the inner beam 108b.

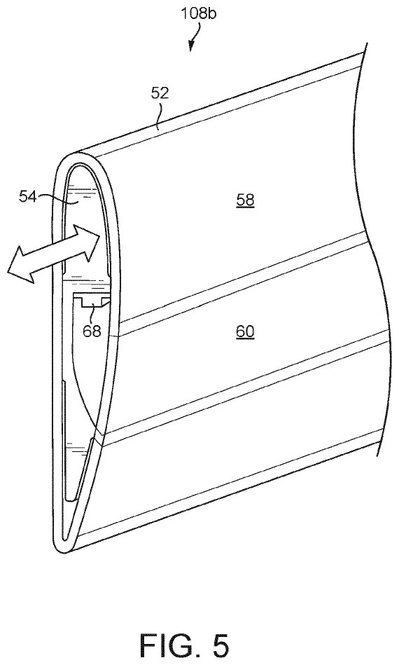

The carrier 54 is a rigid elongate member which may be formed from a metal. In particular, the carrier 54 may be formed from aluminium, and may particularly be an aluminium extrusion. The carrier 54 has a cross-section which generally conforms to the cavity 56 within the outer cover 52 such that the carrier 54 can be inserted into the cavity 56. Specifically, the carrier 54 is slid into the outer cover 52 along its length, as denoted by the arrow in FIG. 5.

The carrier 54 provides structural rigidity to the plastic outer cover 52.

The carrier 54 is provided with a plurality of protrusions 62. In particular, a protrusion 62 is provided on a front surface of the carrier 54 (i.e. on an outer surface which faces out of the ORDC 2 and thus away from the shelves 17) and a pair of protrusions 62 are provided on a rear surface of the carrier 54 (i.e. on an inner surface which faces into the ORDC 2 and thus towards the shelves 17). The protrusions 62 may extend along the length of the carrier 54 and thus form ridges. Alternatively, each of the protrusions 62 may be formed as a set of discrete protruding portions which are provided at intervals along the length of the carrier 54.

The protrusions 62 are raised above the remainder of the carrier 54 and so only the protrusions 62 contact an interior surface of the outer cover 52 as the carrier 54 is slid along its length. The protrusions 62 thus reduce the surface area of the carrier 54 which is brought into contact with the interior surface of the outer cover 52 and so reduce friction during insertion.

As described previously, the carrier 54 generally conforms to the cross-section of the cavity 56; however, a recess 57 is provided along the rear surface of the carrier 54. The recess 57 extends along the length of the carrier 54 and defines a reflector surface 64 and a mounting surface 66. As shown, the pair of protrusions 62 provided on the rear surface of the carrier 54 are provided either side of the recess 57.

A light source 68 is mounted to the mounting surface 66. The light source 68 may comprise a plurality of discrete light sources spaced at intervals along the length of the carrier 54. For example, the light source 68 may be an LED strip light. A power source may be provided on-board the inner beam 108b (e.g. on the carrier 54 or at least within the outer cover 52) for powering the light source 68. Alternatively, the power source may be remote from the inner beam 108b. For example, the light source 68 may be powered by the ORDC 2 itself.

The mounting surface 66 is substantially perpendicular to the inner surface of the outer cover 52 and faces downwards towards the lower edge. The mounting surface 66 sits above the transparent portion 60 of the outer cover 52 and thus lies behind the upper portion of the inner surface formed by the opaque portion 58. Accordingly, the light source 68 is concealed by the opaque portion 58 such that it is not visible when viewed at the level of the transparent portion 60.

At the interface between the reflector surface 64 and the mounting surface 66, the reflector surface 64 is spaced from the inner surface of the outer cover 52 by the mounting surface 66 and is substantially perpendicular to the mounting surface 66. The reflector surface 64 has a curved section such that it turns towards the inner surface of the outer cover 52. The reflector surface 64 contacts the outer cover 52 at the lower edge of the transparent portion 60. The reflector surface 64 is configured to guide (i.e. reflect) the light from the light source 68 towards the transparent portion 60 of the outer cover 52. The reflector surface 64 may be provided with a mirrored coating or layer, or the bare metal may be sufficiently reflective to reflect light towards the transparent portion 60. The carrier 54 may act as a heat sink for the light source 68.

Light from the light source 68 passes through the transparent portion 60 and is emitted from the inner surface of the inner beam 108b. The light source 68 is thus able to illuminate products on the shelf 17 to which the flow control device 102 is connected or on other shelves 17, particularly the shelf 17 below.

The disclosure is not limited to the embodiments described herein, and may be modified or adapted without departing from the scope of the present disclosure.

For example, the outer cover 52 may be formed so as to be entirely transparent (or translucent), rather than having the opaque portion 58 described previously. The light may, however, still be emitted from only a portion of the outer cover 52 (i.e. a window extending along the length of the outer cover 52) by virtue of the carrier 54 which prevents light from reaching other areas of the outer cover 52. In such an example, the carrier 54 may be provided with an overhang projecting from an inner end of the mounting surface 66 so as to conceal the light source 68, if desired.

It will be appreciated that the protrusions 62 could instead (or as well) be formed as part of the outer cover 52 (i.e. on the interior surface) instead of the carrier 54.

Although the disclosure has been described with reference to an open refrigerated display case, it may also be utilised on closed refrigerated display cases with doors.

Although the disclosure has been described with reference to a flow control device 102 having a pair of stabilising beams, it will be appreciated that it may be applied to other types of flow control device, such as those having only a single beam.

1. A flow control device for controlling an air curtain formed across a display area of a refrigerated display case, the flow control device comprising:
a stabilising beam comprising an elongate outer cover and a carrier;
wherein the outer cover forms a continuous boundary which defines a cavity extending along the length of the outer cover;
wherein the carrier is slidably received within the cavity along the length of the outer cover;
wherein the carrier is provided with a light source and wherein at least a portion of the outer cover is transparent or translucent such that light emitted by the light source is emitted from the outer cover to provide illumination.

2. The flow control device according to claim 1, wherein the outer cover is formed from a plastic material.

3. The flow control device according to claim 1, wherein the outer cover comprises an opaque portion and the transparent or translucent portion.

4. The flow control device according to claim 3, wherein the opaque portion is coextruded with the transparent or translucent portion.

5. The flow control device according to claim 1, wherein the carrier is formed from metal.

6. The flow control device according to claim 5, wherein the carrier is an aluminium extrusion.

7. The flow control device according to claim 1, wherein the carrier comprises a recess having a mounting surface and a reflector surface; wherein the light source is mounted to the mounting surface and is configured to direct light towards the reflector surface which reflects the light through the outer cover.

8. The flow control device according to claim 1, wherein the carrier and/or an interior surface of the outer cover comprises a plurality of protrusions to allow the carrier to slide into the cavity.

9. The flow control device according to claim 1, wherein the flow control device is configured to be positioned so that the stabilising beam is spaced away from an adjacent shelf of the refrigerated display case such that light emitted from the outer cover illuminates products supported on and/or below the adjacent shelf

10. The flow control device according to claim 1, wherein the stabilising beam is a first stabilising beam and the flow control device further comprises a second stabilising beam spaced from the first stabilising beam to form a first slot therebetween; wherein the flow control device is configured such that the first stabilising beam is spaced from an adjacent shelf in use to form a second slot therebetween.

11. A refrigerated display case comprising:
a refrigerated display area which comprises a shelf;
an air outlet and an air inlet opening into the display area and spaced from one another;
a duct fluidically coupling the air inlet to the air outlet, the duct being configured to direct air flow out of the air outlet across the display area and toward the air inlet to form an air curtain across the front of the display area; and
a flow control device according to any of the preceding claims, the flow control device being associated with the shelf;
wherein light emitted from the outer cover illuminates products supported on and/or below the associated shelf.

12. The flow control device according to claim 2, wherein the outer cover comprises an opaque portion and the transparent or translucent portion.
